(19) United States
(12) Patent Application Publication
(10) Pub. No.: US 2023/0025099 A1
(43) Pub. Date: Jan. 26, 2023

(54) ANTI-SPLASH WATER OUTLET STRUCTURE

(71) Applicant: Spark (Xiamen) Sanitary Ware Co., Ltd., Xiamen (CN)

(72) Inventor: Huilong SHAO, Xiamen (CN)

(21) Appl. No.: 17/689,590

(22) Filed: Mar. 8, 2022

(30) Foreign Application Priority Data
Jul. 21, 2021 (CN) 202110822517.9

(51) Int. Cl. E03C 1/08; B05B 1/22; B05B 12/18

(52) U.S. Cl. CPC E03C 1/08; B05B 1/22; B05B 12/18

(57) ABSTRACT

The present disclosure relates to an anti-splash water outlet structure. A water path core is provided in a water outlet body, a first water path is formed in the water path core, and a second water path is formed between the outer sidewalls of the water path core and the inner sidewalls of the water outlet body. The water outlet of the second water path surrounds the the water outlet of the first water path, and the water curtain flowing out of the second water path surrounds the water outlet of the first water path. The technical scheme of the present disclosure can avoid the splash of the water column while ensuring the water output of the kitchen faucet and the shower. It has the advantages of simple structure, low cost and good anti-splash effect.

### RELATED APPLICATIONS

The present disclosure claims priority to Chinese Patent Application No. 202110822517.9, filed on Jul. 21, 2021, which is incorporated herein by reference.

### TECHNICAL FIELD

The present disclosure relates to the technical field of sanitary equipment, and in particular, to an anti-splash water outlet structure.

### BACKGROUND

In kitchens, bathrooms, etc., it is necessary to use water outlet structures such as kitchen faucets and showers. Through various water outlet structures, water outlets of different shapes and priorities can be obtained to adapt to different use environments. Existing water outlet structures such as kitchen faucets and showers are all provided with a plurality of water paths and water outlets, and each of them can switch the plurality of water outlets to realize the adjustment of the water outlet mode. When using the existing shower, due to the high water pressure, when the water column is sprayed, it is easy to splash, and the water is splashed everywhere, causing the ground to be slippery, moldy, and difficult to clean. Although the water splash can be reduced by reducing the water pressure, it leads to the problem of reducing the water output of the shower, which is not worth the loss. In addition, the control of water pressure also leads to the complication of water path components, which increases the cost of the shower, and is not conducive to popularization and use.

### SUMMARY

To this end, it is necessary to provide an anti-splash water outlet structure in view of the problem that the existing kitchen faucets and showers are prone to splashing water.

An anti-splash water outlet structure includes a water outlet body and a water path core provided in the water outlet body; a first water path is formed in the water path core, and a second water path is formed between outer sidewalls of the water path core and inner sidewalls of the water outlet body; an water outlet of the second water path surrounds a water outlet of the first water path, and a water curtain flowing out of the second water path surrounds the water outlet of the first water path.

Wherein, in order to guide the water flow in the second water path to the inner sidewalls of the water outlet body, so as to form an annular water curtain, the outer sidewalls of the water path core are provided with an annular convex guide ring, and the guide ring guides a water in the second water path to the inner sidewalls of the water outlet body, such that the water flows out in an annular water curtain shape along the inner sidewalls of the water outlet body.

Wherein, in order to have space for the water flow of the second water path to be directed to the inner sidewalls of the water outlet body, the water outlet body comprises a first body part and a second body part that are connected to each other; the second body part has an inner diameter greater than the first body part, and the water path core has an outer diameter smaller than the first body part.

Wherein, in order to evenly discharge the water from the annular water curtain, the water path core is coaxially connected to the first body part and the second body part; the guide ring is provided between the water path core and the second body part, and guides the water to inner sidewalls of the second body part, such that the water flows out in an annular water curtain shape along the inner sidewalls of the second body part.

Wherein, in order to fix the water path core in the first body part, and at the same time the water flow can flow between the water flow core and the first body part, the first body part is provided with a connecting part radially inwardly protruding, the water path core is connected to the water outlet body through the connecting part; the connecting part is provided with a gap or a through hole in an axial direction, for the water to flow therethrough.

Wherein, in order to allow the water flow to flow evenly around the water flow core, so that the water from the annular water curtain is evenly discharged, a plurality of the gaps or through holes are provided equally around the water path core; the connecting part is provided with an internal thread, the water path core is connected to the water outlet body through a thread.

Wherein, in order to reasonably guide the water flow to the inner sidewalls of the second body part to form an annular water curtain, the guide ring comprises a first guide loop that guides the water radially outward; and a second guide sleeve that guides the water axially toward the first body part; the second guide sleeve is provided between the water path core and the second body part; the water flows from a space between inner sidewalls of the second guide sleeve and the water path core to a space between outer sidewalls of the second guide sleeve and the water outlet body, and flows out along the inner sidewalls of the water outlet body.

Wherein, in order to guide the water flowing out of the first body part to the guide ring, the second body part is provided with a guide portion extending axially and connected to the first body part, an inner diameter of the guide portion is a same as that of the first body part; the guide portion is located between the water path core and the second guide sleeve, and the guide portion is provided with a plurality of radial water flow gaps or water flow holes.

Wherein, in order to guide and accelerate the water flow, and form a water curtain with less water, each of the plurality of water flow gaps or the water flow holes extends spirally outward from inner sidewalls to outer sidewalls of the guide portion.

Wherein, in order to strengthen the impact force of the first water path and improve the flushing efficiency, the water outlet of the water path core is a circular hole or an oval hole.

In the technical solution of the present disclosure, a core is provided in the water outlet body to form a first water path and a second water path, and the water outlet of the second water path surrounds the water outlet of the first water path. When the water comes out, the two water paths come out at the same time, the water from the first water path is surrounded by the water curtain, and the splashed water is also blocked and absorbed by the water curtain. The technical solution of the present disclosure can avoid the splash of the water column while ensuring the water output of the kitchen faucet and shower and the like. It has the advantages of simple structure, low cost and good anti-splash effect.

### BRIEF DESCRIPTION OF DRAWINGS

FIG. 1 is an overall schematic diagram showing an anti-splash water outlet structure of an embodiment according to the present disclosure;

FIG. 2 is a front view of the anti-splash water outlet structure of the embodiment shown in FIG. 1;

FIG. 3 is a schematic cross-sectional view in the direction A-A of the anti-splash water outlet structure of the embodiment shown in FIG. 2;

FIG. 4 is the structural representation showing the water path core according to the present disclosure;

FIG. 5 is a schematic structural diagram of the water path core from another perspective in the present disclosure;

FIG. 6 is a front view of the water path core shown in FIG. 4;

FIG. 7 is a schematic cross-sectional view in the direction B-B of the water path core shown in FIG. 6;

FIG. 8 is a schematic structural diagram of a water outlet body in the present disclosure;

FIG. 9 is a front view of the water outlet body shown in FIG. 8;

FIG. 10 is a schematic cross-sectional view in the direction C-C of the water outlet body shown in FIG. 9;

FIG. 11 is a schematic diagram of the water outlet of the anti-splash water outlet structure according to the present disclosure when the water outlet is oval;

FIG. 12 is a schematic diagram of the water outlet of the anti-splash water outlet structure according to the present disclosure when the water outlet is circular.

In the accompanying drawings, the list of components represented is as follows:

1, water outlet body; 11, first body part; 111, connecting part; 12, second body part; 121, guide portion;

2, water path core; 21, guide ring; 211, first guide loop; 212, second guide sleeve.

### DESCRIPTION OF EMBODIMENTS

In order to make the above-mentioned objects, features and advantages of the present disclosure more obvious and easy to understand, the specific embodiments of the present disclosure will be described clearly and completely below with reference to the accompanying drawings. Obviously, the specific details described below are only some of the embodiments of the present disclosure, and the present disclosure can also be practiced in many other embodiments than those described herein. Based on the embodiments of the present disclosure, all other embodiments obtained by those of ordinary skill in the art without inventive work fall within the protection scope of the present disclosure.

It should be noted that when an element is referred to as being “fixed” to another element, it can be directly on the other element or intervening elements may also be present. When an element is referred to as being “connected” to another element, it can be directly connected to the other element or intervening elements may also be present. The terms “vertical”, “horizontal”, “left”, “right” and similar expressions used herein are for the purpose of illustration only and do not represent the only embodiment.

Unless otherwise defined, all technical and scientific terms used herein have the same meaning as commonly understood by one of ordinary skill in the art to which the present disclosure belongs. The terms used herein in the description of the present disclosure are intended for describing specific embodiments only, and are not intended to limit the present disclosure.

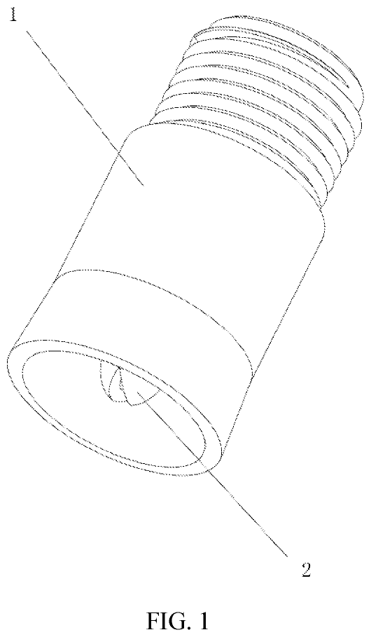

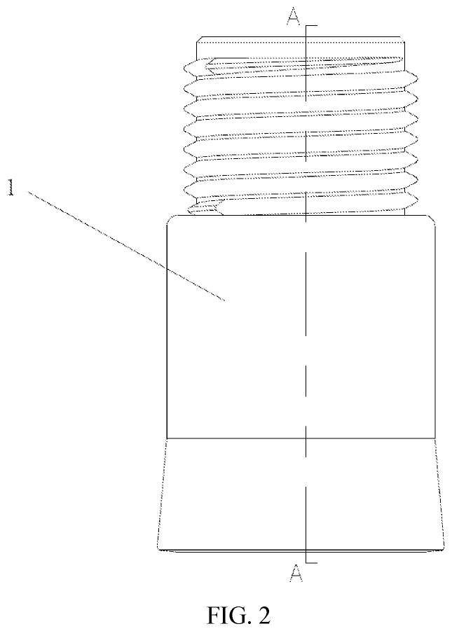

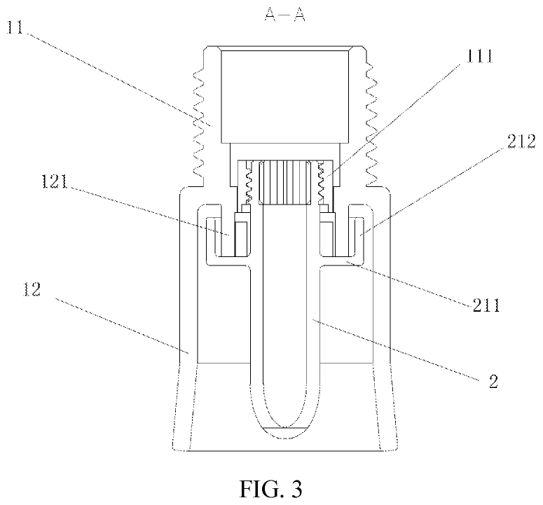

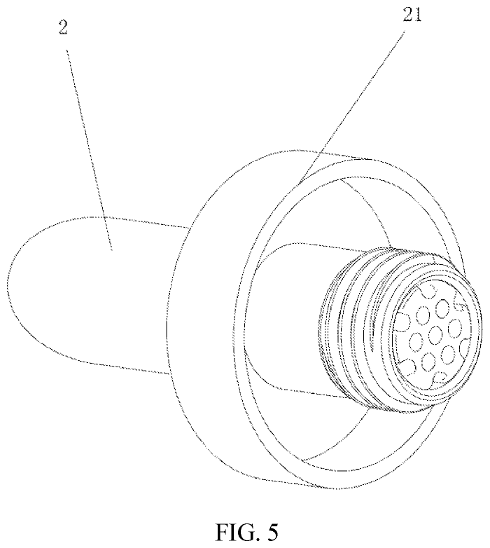

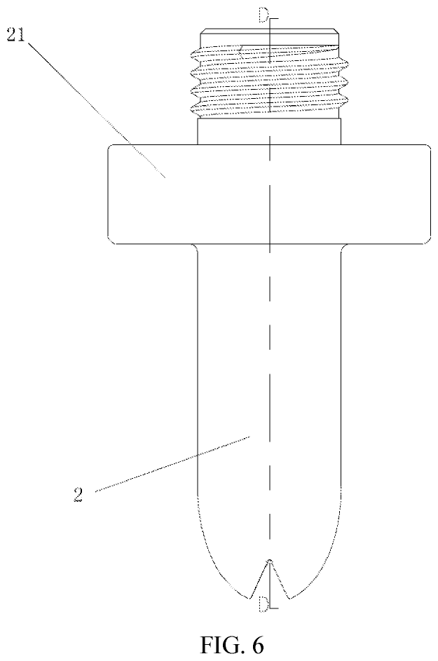

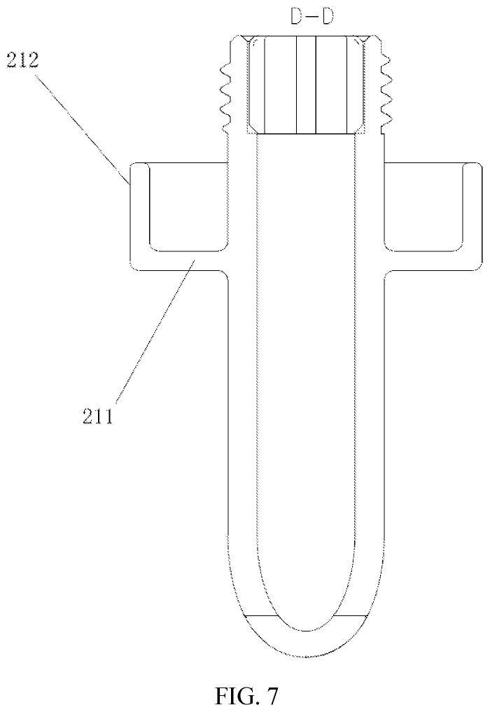

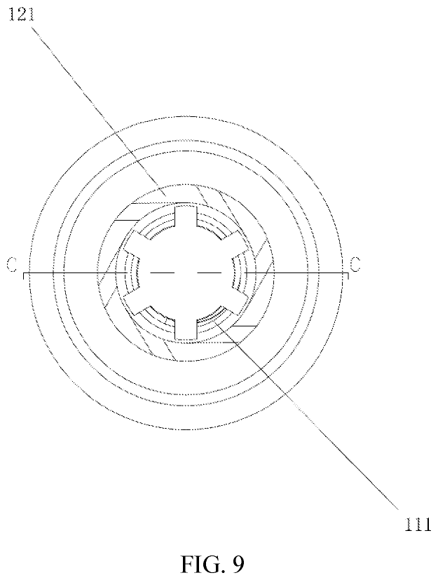

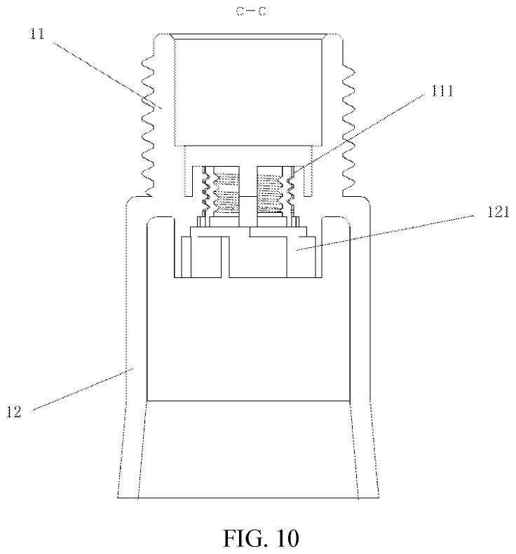

In one embodiment, please refer to FIG. 1 to FIG. 10, an anti-splash water outlet structure may include a water outlet body 1 and a water path core 2. The water path core 2 may be provided in the water outlet body 1, and the water path core 2 may be formed in the first water path, a second water path may be formed between the outer sidewalls of the water path core 2 and the inner sidewalls of the water outlet body 1. The water outlet of the second water path the water outlet of the first water path, and the water curtain flowing out of the second water path surrounds the water outlet of the first water path.

The water outlet of the second water path in the embodiment is annular. It should be noted that the water outlet of the second water path may be circular, or may be in other shapes such as square, triangle, etc., as long as it is a closed shape that can surround the first water path, which is not limited to the description in the embodiment.

The technical solution of the present disclosure is that a core is provided in the water outlet body 1 to form a first water path and a second water path, and the water outlet of the second water path is annular, surrounding the water outlet of the first water path. When the water comes out, the two water paths come out at the same time, the water coming out of the first water path is surrounded by the annular water curtain, and the splashed water is also blocked and absorbed by the annular water curtain. The technical scheme of the present disclosure can avoid the splash of the water column, while ensuring the water output of the water outlet structures such as the kitchen faucets and the showers. It has the advantages of simple structure, low cost and good anti-splash effect.

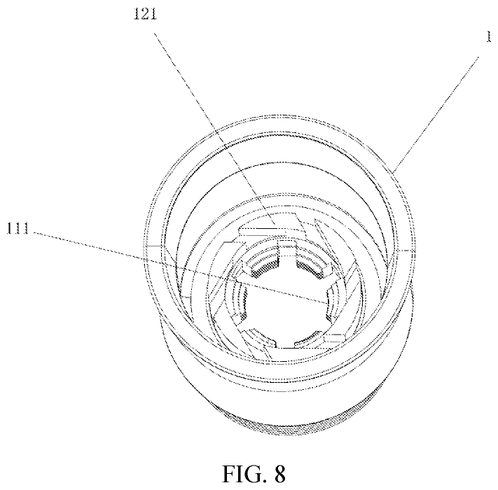

On the basis of the present embodiment, referring to FIGS. 8, 9 and 10, the water outlet body 1 may include a first body part 11 and a second body part 12 that are connected to each other. The inner diameter of the second body part 12 may be greater than that of the first body part 11; the outer diameter of the water path core 2 may be smaller than that of the first body part 11.

It should be noted that the inner wall of the water outlet body 1 may be stepped and divided into a first body part 11 and a second body part 12. The second body part 12 has a larger diameter so that the water flow of the second water path has space to be directed to the inner sidewalls of the water outlet body 1.

On the basis of the present embodiment, in order to guide the water flow in the second water path to the inner sidewalls of the water outlet body 1 so as to form an annular water curtain, the outer sidewalls of the water path core 2 may be provided with an annular convex guide ring 21 to guide the water in the second water path to the inner sidewalls of the water outlet body 1, such that the water flows out in an annular water curtain shape along the inner sidewalls of the water outlet body 1. Of course, the water flow can also be guided to the inner sidewalls of the water outlet body 1 through other structures, for example, an annular guide ring 21 is provided on the body part to directly guide the water to the inner sidewalls of the water outlet body. The realization structure is not limited by the description in the present embodiment.

Specifically, in order to reasonably guide the water flow to the inner sidewalls of the second body part 12 to form an annular water curtain, the guide ring 21 may include a first guide loop 211 that guides the water radially outward; and a second guide sleeve 212 that guides the water to the first body part 11 in an axial direction. The second guide sleeve 212 may be provided between the water path core 2 and the second body part 12. The water may flow from a space between the inner sidewalls of the second guide sleeve 212 and the water path core 2 a space between the outer sidewalls of the second guide sleeve 212 and the water outlet body 1, and may flow out along the inner sidewalls of the water outlet body 1. At this time, in the cross-section of the guide ring 21, the cross-sections of the first guide loop 211 and the second guide sleeve 212 may be L-shaped.

It should be noted that the corner of the inner sidewalls of the connection between the first body part 11 and the second body part 12 may be chamfered. This structure cooperates with the L-shaped guide ring 21 to guide the water flow appropriately.

Of course, the shape of the guide ring 21 can also be other, for example, the water may be guided to the sidewalls of the water outlet body 1 through an arc structure. Its shape is not limited to the description in the present embodiment.

Among them, in order to guide the water flowing out of the first body part 11 to the guide ring 21, the second body part 12 may be provided with a guide portion 121 which extends axially and is connected with the first body part 11. The inner diameter of the guide portion 121 may be the same as that of the first body part 11. The guide portion 121 may be located between the water path core 2 and the second guide sleeve 212, and the guide portion 121 may be provided with a plurality of radial water flow gaps or water flow holes. Wherein, the water flow gaps or the water flow holes extend spirally outward from the inner sidewalls to the outer sidewall of the guide portion 121. The water flow can be guided and accelerated through the helical through holes or gaps to form a water curtain with less water. Of course, the guide portion 121 may not be provided, and its structure is not limited by the description in the present embodiment.

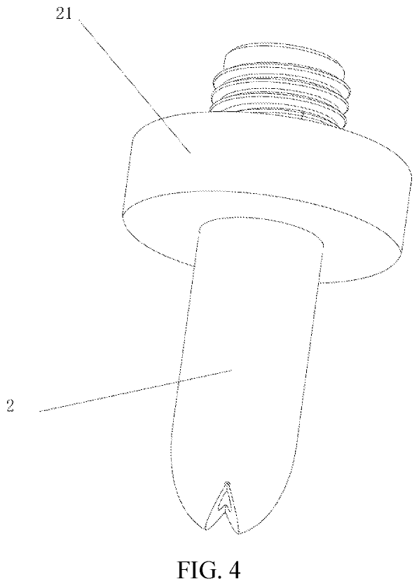

On the basis of the present embodiment, referring to FIGS. 4, 5, 6 and 7, the water path core 2 may be coaxially connected to the first body part 11 and the second body part 12, and the guide ring 21 may be provided between the water path core 2 and the second body part 12, and can guide the water to the inner sidewalls of the second body part 12, so that the water flows out along the inner sidewalls of the second body part 12 in an annular water curtain shape. This structure makes the distances between the water path core 2 and the inner sidewalls surrounding the water outlet body 1 equal, so that the water is discharged evenly from the annular water curtain.

Further, in order to fix the water path core 2 in the first body part 11 and at the same time the water flow can flow between the water flow core and the first body part 11, the first body part 11 may be provided with a connecting part 111 that protrudes radially inward, and the water path core 2 may be connected with the water outlet body 1 through the connecting part 111. The connecting part 111 may be provided with a gap or through hole in the axial direction for the water to flow through.

In the present embodiment, specifically, in order for the water flow to flow evenly around the water flow core, so that the annular water curtain discharges water evenly, a plurality of gaps or through holes may be provided, and they are equally provided around the water path core 2. The connecting part 111 may be provided with internal threads, and the water path core 2 may be connected to the water outlet body 1 through the threads. Of course, the water path core 2 can also be connected to the water outlet body 1 through other structures, such as a buckle etc., and the structure thereof is not limited to the description in the present embodiment.

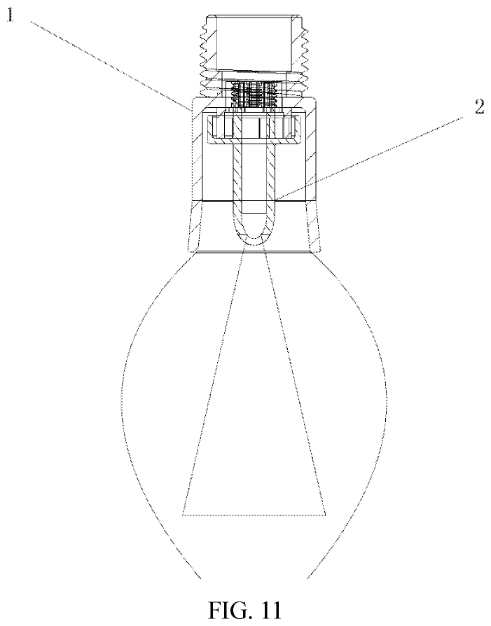

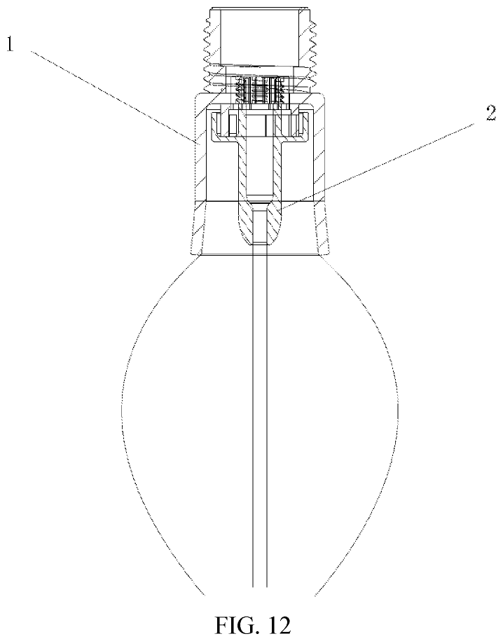

Further, the water outlet of the water path core 2 may be a circular hole or an oval hole. Referring to FIG. 12, when the water outlet is a circular hole, the water outlet of the first water path is a strong water column. As shown in FIG. 11, when the water outlet is an oval hole, the water outlet of the first water path is flaky water. The arrangement of the two water outlet structures can strengthen the impact force of the first water path and improve the flushing efficiency. Of course, the water outlet of the water path core 2 can also be in other shapes to meet different requirements, and its structure is not limited to the description in the present embodiment.

The technical solution of the present disclosure is that by setting the annular water outlet, the second water path is surrounded by the first water path, and the splash from the water outlet of the first water path can be blocked and absorbed by the annular water curtain of the second water path, which can effectively solve the problem of water splashing. The structure is simple and practical, and the cost is low.

The technical features of the above embodiments can be combined arbitrarily. For the sake of brevity, not all possible combinations of the technical features in the above embodiments are described. However, as long as there is no contradiction in the combination of these technical features, all of them should be considered to fall within the range described in the present specification.

The above embodiments are only intended to represent several embodiments of the present disclosure, and the descriptions thereof are specific and detailed, but they should not be construed as a limitation on the scope of the present disclosure. It should be pointed out that for those of ordinary skill in the art, without departing from the concept of the present disclosure, several modifications, substitutions and improvements can be made, and these should all be covered within the protection scope of the present disclosure. Therefore, the protection scope of the present disclosure shall be subject to the appended claims.

What is claimed is:

1. An anti-splash water outlet structure, comprising:
a water outlet body; and
a water path core provided in the water outlet body, wherein:
a first water path is defined in the water path core,
a second water path is defined between outer sidewalls of the water path core and inner sidewalls of the water outlet body,
a water outlet of the second water path surrounds a water outlet of the first water path, and
a water curtain flowing out of the second water path surrounds the water outlet of the first water path.

2. The anti-splash water outlet structure according to claim 1, wherein:
the outer sidewalls of the water path core are provided with an annular convex guide ring, and
the annular convex guide ring guides water in the second water path to the inner sidewalls of the water outlet body, such that the water flows out in an annular water curtain shape along the inner sidewalls of the water outlet body.

3. The anti-splash water outlet structure according to claim 2, wherein:
the water outlet body comprises a first body part and a second body part that are connected to each other,
the second body part has an inner diameter greater than an inner diameter of the first body part, and
the water path core has an outer diameter smaller than an outer diameter of the first body part.

4. The anti-splash water outlet structure according to claim 3, wherein:
the water path core is coaxially connected to the first body part and the second body part,
the annular convex guide ring is provided between the water path core and the second body part, and
the annular convex guide ring guides the water to inner sidewalls of the second body part, such that the water flows out in the annular water curtain shape along the inner sidewalls of the second body part.

5. The anti-splash water outlet structure according to claim 4, wherein:
the first body part is provided with a connecting part radially inwardly protruding,
the water path core is connected to the water outlet body through the connecting part, and
the connecting part is provided with a gap or through hole in an axial direction for the water to flow therethrough.

6. The anti-splash water outlet structure according to claim 5, wherein:
a plurality of the gaps or through holes are provided equally around the water path core,
the connecting part is provided with an internal thread, and
the water path core is connected to the water outlet body through a thread.

7. The anti-splash water outlet structure according to claim 3, wherein:
the annular convex guide ring comprises a first guide loop that guides the water radially outward and a second guide sleeve that guides the water axially toward the first body part,
the second guide sleeve is provided between the water path core and the second body part,
the water flows from a space between inner sidewalls of the second guide sleeve and the water path core to a space between outer sidewalls of the second guide sleeve and the water outlet body and flows out along the inner sidewalls of the water outlet body.

8. The anti-splash water outlet structure according to claim 7, wherein:
the second body part is provided with a guide portion extending axially and connected to the first body part,
an inner diameter of the guide portion is the same as an inner diameter of the first body part,
the guide portion is located between the water path core and the second guide sleeve, and
the guide portion is provided with a plurality of radial water flow gaps or water flow holes.

9. The anti-splash water outlet structure according to claim 8, wherein each of the plurality of radial water flow gaps or the water flow holes extends spirally outward from inner sidewalls to outer sidewalls of the guide portion.

10. The anti-splash water outlet structure according to claim 1, wherein a water outlet of the water path core is a circular hole or an oval hole.
